(19) United States
(12) Patent Application Publication
(10) Pub. No.: US 2009/0147709 A1
(43) Pub. Date: Jun. 11, 2009

(54) RECEIVER CHANNEL FEEDBACK THROUGH BEACONS

(76) Inventors: Alaa Muqattash, San Diego, CA (US); Ghobad Heidari-Bateni, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/952,392

(22) Filed: Dec. 7, 2007

(51) Int. Cl. H04B 7/00

(52) U.S. Cl. 370/310

(57) ABSTRACT

According to various embodiments a receiver may include information elements in its beacon. The information elements can then be used to send feedback information about packets received during the previous superframe(s). This feedback information may contain some acknowledgement information. For example, the feedback information may include information elements that include acknowledgement information that acknowledge the reception of previously transmitted packets. According to an embodiment of the invention, systems and methods to provide feedback information comprising receiving a packet; determining feedback information based on the received packet; and transmitting a beacon. The beacon comprises a frame header, including routing information for the frame; a beacon parameter, including signaling information; and an information element comprising the feedback information for the received packets.

### TECHNICAL FIELD

The present invention relates to communications, and more particularly, some embodiments relate to communications methods and systems that include beacon transmissions.

### DESCRIPTION OF THE RELATED ART

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

For example, communication networks, both wired and wireless, are now commonplace in many home and office environments. Such networks allow various heretofore independent devices to share data and other information to enhance productivity or simply to improve their convenience to the user. One such communication network that is gaining widespread popularity is an exemplary implementation of a wireless network such as that specified by the WiMedia-MBOA (Multiband OFDM Alliance). Other exemplary networks include the Bluetooth® communications network and various IEEE standards-based networks such as 802.11 and 802.16 communications networks, to name a few.

Feedback information from a receiver can significantly improve the performance of adaptive transmission techniques at the source device. For example, a source device may receive an acknowledgment from a receiver device. This acknowledgement may include feedback regarding the reception of previously transmitted packets. This feedback might be used by the source device to determine measures of signal quality, such as, for example, packet error rates. These measures of signal quality might then be used to determine the best transmission rate and packet size to adapt to wireless channel variations. For example, different transmission rates and packet sizes might be tested and a transmission rate and packet size that has the best packet error rates might be selected by the source device for future transmissions. This process might be repeated from time to time, for example, as transmission conditions change.

Such feedback information is readily available in cases when the source device uses the Acknowledgement (“ACK”) such as an immediate Acknowledgement (“Imm-ACK”) or a Block Acknowledgement (“Block-ACK”). For example, in some communication systems an ACK Policy field may indicate the type of acknowledgement requested by the source device. One example ACK policy is the WiMedia MAC Protocol Release 1.0, incorporated herein by reference.

The WiMedia MAC protocol, however, does not include any mechanism to convey such feedback information in the cases when the source device uses the do-not-use-any-acknowledgement (“no-ACK”) policy. Acknowledgement (ACK) and retransmission are usually adopted by the MAC layer to correct transmission errors. For this reason the no-ACK policy might generally be used for transmission not requiring reliable delivery.

Using a no-ACK policy may be of particular importance in real-time communication. Generally real-time communications do not use retransmission because of strict delay constraints. In such systems the source device does not have the information required (i.e., Acks) to determine the packet error rate (“PER”) and so it cannot adapt to changing transmission environments by, for example, by testing different transmission rates and packet sizes and selecting a transmission rate and packet size that has the best packet error rates. For various communication systems, including, for example, real-time communication systems, it may be advantageous to include a mechanism that enables a receiver to send some feedback information to its source device, such that the latter can adapt its link transmission parameters efficiently.

### BRIEF SUMMARY OF EMBODIMENTS OF THE INVENTION

According to various embodiments, a receiver may include information elements (“IEs”) in its beacon. The beacon may, for example, be in a superframe. The information elements can then be used to send feedback information about packets received during the previous superframe(s). For example, a No-ACK feedback information element format might include element identification bits, e.g, an octet (8 bits). Additionally, the No-ACK feedback information element might be of a variable length. Accordingly, some bits, e.g., an octet, may indicate the length of the No-ACK feedback information element. Finally, the feedback bits may be included.

According to some embodiments, this feedback information may contain some acknowledgement information for packets received for a specific data stream that have the ACK policy set to No-ACK. For example, the feedback information may include information elements that include acknowledgement information that acknowledge the reception of previously transmitted packets. This information may be used to construct measures of various communication signal properties such packet error rates.

According to another embodiment, each information element might specify a certain source device. For example, the source device may be indicated by the device address (“DevAddr”). In this way a receiving device can determine which transmitting device transmitted a particular information element.

According to another embodiment, this feedback may be in the form of periodic error rates for a stream. For example, the feedback field might include DevAddr, stream index and periodic error rate fields. These fields may be various sizes, for example the DevAddr might be two octets and the stream index and periodic error rate fields might each be 1 octet. It will be understood, however, that the size and order of each of these fields may vary from implementation to implementation.

In some embodiments, a receiver may include this information whenever it receives packet that have the ACK policy set to No-ACK only when the transmitters indicates its wish to receive such information, or may include that feedback in every beacon. A transmitter may indicate its wish to receive such information by including an information element in its beacon. An example of the format of such an information element might include a single octet element identification field, followed by a single octet length filed and some number of three octet send feedback fields. The send feedback field may be formatted to include two octets for the DevAddr and one octet for the stream index. Again, it will be understood, however, that the size and order of each of these fields may vary from implementation to implementation. Additionally, the number of send feedback fields may vary based on the information stored in the length field.

According to another embodiment, a source device can then input any feedback information it receives into its link adaptation algorithm in order to improve a certain performance measure. For example, this feedback information from a receiver can significantly improve the performance of adaptive transmission techniques at the source device by help the source to determine the best transmission rate and packet size to adapt to wireless channel variations.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that can serve as an example environment in which the present invention can be implemented.

FIG. 2 is a diagram illustrating bandwidth that can be divided into superframes, which in turn can be divided into time slots.

FIG. 3 is a diagram illustrating one example beacon frame in accordance with the systems and methods described herein.

FIG. 4 is a flowchart illustrating one example method in accordance with the systems and methods described herein.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

For example, communication networks and other channels, both wired and wireless, are now commonplace in many home and office environments. Such networks allow various heretofore independent devices to share data and other information to enhance productivity or simply to improve their convenience to the user. One such communication network that is gaining widespread popularity is an exemplary implementation of a wireless network such as that specified by the WiMedia-MBOA (Multiband OFDM Alliance). Other exemplary networks include the Bluetooth® communications network and various IEEE standards-based networks such as 802.11 and 802.16 communications networks, to name a few.

According to various embodiments, a receiver may include information elements (“IEs”) in its beacon. The information elements can then be used to send feedback information about packets received during the previous superframe(s). This feedback information may contain some acknowledgement information, e.g., for packets received for a specific data stream that has the ACK policy set to No-ACK. For example, the feedback information may include information elements that include acknowledgement information. The acknowledgement information may acknowledge the reception of previously transmitted packets and, for example, packet error rates, bit error rates, signal-to-noise ratio, or other measures of signal quality. This acknowledgement information might be, for example, included in the information element for transmission has part of the beacon.

Before describing the invention in detail, it is useful to describe an example environment in which the invention can be implemented. One such example is a wireless beaconing network in which multiple electronic devices (for example, computers and computing devices, cellular telephones, personal digital assistants, motion and still cameras, among others) can communicate and share data, content and other information with one another. One example of such a network is that specified by the WiMedia standard (within WiMedia and Multi-Band OFDM Alliance). From time-to-time, the present invention is described herein in terms of a distributed network or in terms of a WiMedia standard. Description in terms of these environments is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to a distributed wireless network, nor is it limited to a WiMedia standard described as one implementation of the example environment.

Most network standards specify policies or rules that govern the behavior of network connected devices. The WiMedia standard specifies the mechanism and policies that are to be followed by W-USB and WiNet compliant devices in order to allow for an ad hoc and distributed network of such devices to operate efficiently.

In most distributed networks, the network of the devices is maintained by requiring all devices to announce parameters such as their presence, their capabilities and their intentions for reserving transmission slots and so on. For example, with the WiMedia standard, this can be done during what are referred to as beacon period time slots. According to this standard, devices joining the network are expected to monitor the beacon period to learn about the network status and parameters before attempting to use the network. In other network configurations, beacon periods are similarly used to allow management of network devices as described more fully below. Thus, beacon periods are one form of window or network period during which scheduling or other housekeeping activities can be conducted. Beacon periods in the above-referenced standard, and other time periods used for scheduling or other housekeeping chores in other network configurations, are generally referred to as scheduling windows.

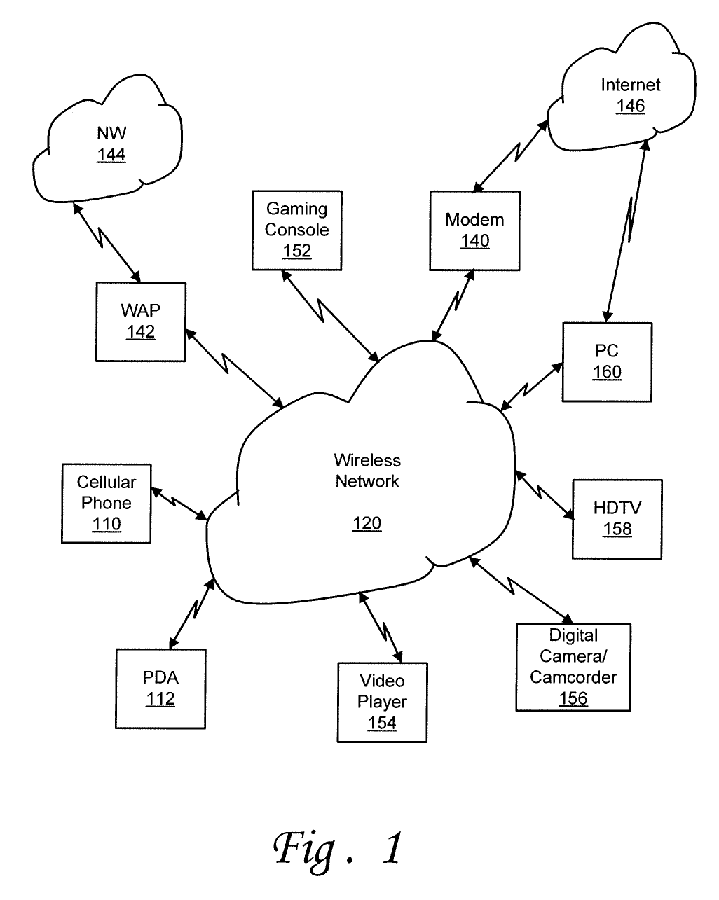

FIG. 1 is a block diagram illustrating one possible configuration of a wireless network that can serve as an example environment in which the present invention can be implemented. Referring now to FIG. 1, a wireless network 120 is provided to allow a plurality of electronic devices to communicate with one another without the need for wires or cables between the devices. A wireless network 120 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 120 operates in a relatively confined area, such as, for example, a home or an office. The example illustrated in FIG. 1 is an example of an implementation such as that which may be found in a home or small office environment. Of course, wireless communication networks and communication networks in general are found in many environments outside the home and office as well. In the example illustrated in FIG. 1, wireless network 120 includes a communication device to allow it to communicate with external networks. More particularly, in the illustrated example, wireless network 120 includes a modem 140 to provide connectivity to an external network such as the Internet 146, and a wireless access point 142 that can provide external connectivity to another network 144.

Also illustrated in the example wireless network 120 are portable electronic devices such as a cellular telephone 110 and a personal digital assistant (“PDA”) 112. Like the other electronic devices illustrated in FIG. 1, cellular telephone 110 and PDA 112 can communicate with wireless network 120 via the appropriate wireless interface. Additionally, these devices may be configured to further communicate with an external network. For example, cellular telephone 110 is typically configured to communicate with a wide area wireless network by way of a base station.

Additionally, the example environment illustrated in FIG. 1 also includes examples of home entertainment devices connected to wireless network 120. In the illustrated example, electronic devices such as a gaming console 152, a video player 154, a digital camera/camcorder 156, and a high definition television 158 are illustrated as being interconnected via wireless network 120. For example, a digital camera or camcorder 156 can be utilized by a user to capture one or more still picture or motion video images. The captured images can be stored in a local memory or storage device associated with digital camera or camcorder 156 and ultimately communicated to another electronic device via wireless network 120. For example, the user may wish to provide a digital video stream to a high definition television set 158 associated with wireless network 120. As another example, the user may wish to upload one or more images from digital camera 156 to his or her personal computer 160 or to the Internet 146. This can be accomplished by wireless network 120. Of course, wireless network 120 can be utilized to provide data, content, and other information sharing on a peer-to-peer or other basis, as the provided examples serve to illustrate.

Also illustrated is a personal computer 160 or other computing device connected to wireless network 120 via a wireless air interface. As depicted in the illustrated example, personal computer 160 can also provide connectivity to an external network such as the Internet 146.

In the illustrated example, wireless network 120 is implemented so as to provide wireless connectivity to the various electronic devices associated therewith. Wireless network 120 allows these devices to share data, content, and other information with one another across wireless network 120. Typically, in such an environment, the electronic devices would have the appropriate transmitter, receiver, or transceiver to allow communication via the air interface with other devices associated with wireless network 120. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

Electronic devices operating as a part of wireless network 120 are sometimes referred to herein as network devices, members or member devices of the network or devices associated with the network. In one embodiment, devices that communicate with a given network may be members or merely in communication with the network.

Some communication networks are divided into periods or frames that can be used for communication and other activities. For example, some networks have a scheduling window such as, for example, a beacon period, for scheduling upcoming communication activities. In addition, some networks have a communication window during which such communication activities take place. In the WiMedia-MBOA standard, the bandwidth is divided into superframes, which in turn are divided into time slots for the transmission and reception of data by the various electronic devices associated with the network.

Some communication networks are divided into periods or frames that can be used for communication and other activities. For example, as discussed above, some networks have a scheduling window such as, for example, a beacon period, for scheduling upcoming communication activities. Also, some networks have a communication window during which such communication activities take place. In the WiMedia-MBOA standard, the bandwidth is divided into superframes, which in turn are divided into time slots for the transmission and reception of data by the various electronic devices associated with the network.

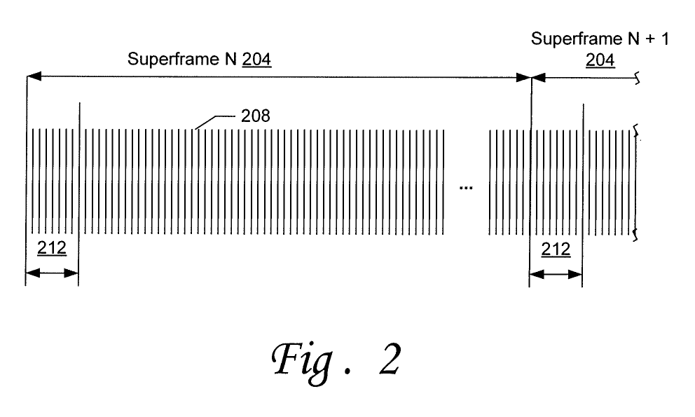

An example of such time slots is illustrated in FIG. 2. Referring now to FIG. 2, in this exemplary environment, the communication bandwidth is divided into superframes 204 (two illustrated), each superframe 204 itself being divided into a plurality of timeslots referred to as Media Access Slots 208. In the example environment, there are 256 media access slots 208 in each superframe 204, although other allocations are possible. Additionally, at the beginning of each superframe 204 is a beacon period 212, which is comprised of a plurality of beaconing slots. In some networks, the beacon period 212 is a period during which devices reserve timeslots and exchange other housekeeping or status information. For example, in the WiMedia-MBOA distributed wireless network, the superframes comprise a beacon period 212, during which devices are awake and receive beacons from other devices.

Superframes in the above-referenced standard, and other time periods used for communications among devices in other network configurations, with or without scheduling windows, are generally referred to herein as communication windows. As noted above, for clarity of description the present invention is described in terms of the example environment, and thus is at times described using the terms superframe and beacon period. As would be apparent to one of ordinary skill in the art after reading this description, the invention applies to other communication formats, including the more general case utilizing scheduling windows and communication windows. Additionally, the invention is not limited to applications where the bandwidth is divided into frames or windows, but can be generally applied to communication channels and networks of various protocols and configurations.

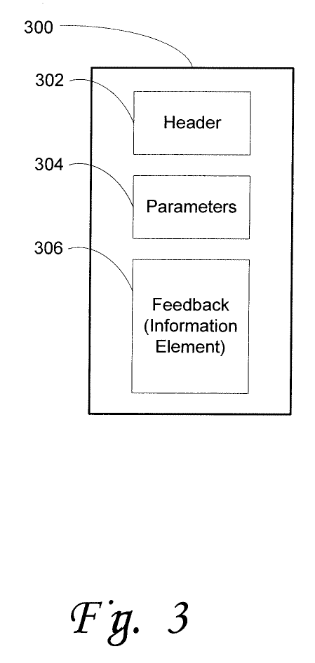

FIG. 3 is a block diagram illustrating an example beacon frame 300 in accordance with one embodiment of the systems and methods described herein. In accordance with one embodiment, beacon frame 300 may be used for transmission during a beacon period. In this way, a wireless device may transmit information elements. These information elements may include feedback information such as, for example, acknowledgement information for packets that have been received. Accordingly, this feedback information may be transmitted from one wireless device to another wireless device, for example, without the use of an acknowledgement such as an Imm-ACK or Block-ACK.

In some cases wireless devices, for example, in an ad hoc wireless communications network, may improve some aspect of the network's performance by transmitting information elements that include acknowledgement information because the wireless devices may modify various aspects of a transmission based on the feedback. For example, a wireless device might change transmission rate, packet size, etc. in response to feedback data received in an information element transmitted as part of a beacon.

In one embodiment, wireless devices may include devices that are enabled to communicate with other devices wirelessly. Examples can include: mobile phones, MP3 players, desktop or notebook computers, handheld computers, or any electronic device that is capable of transmitting or receiving information wirelessly. In some embodiments, each of these devices might communicate more effectively using a wireless network in conjunction with the systems and methods described herein.

In one embodiment, a system using beacon frame 300 might use less network overhead, for example, when compared to a system that used Imm-ACK or Block-ACK. For example, an Ultra Wideband (UWB)/MultiBand OFDM Alliance (MBOA) using the systems and methods described herein might use the same network overhead as a traditional system UWB/MBOA system that is operating using a no acknowledgement policy (No-ACK). The UWB/MBOA system using the systems and methods described herein may, however, have some or all of the advantages of an Immediate Acknowledge (“Imm-ACK”) or Block Acknowledge (“Block-ACK”) without the required extra transmission overhead.

To form the wireless network, beacon frame 300 might enable various devices to detect each other. As discussed above, in one embodiment, beacon frame 300 may be compliant with UWB/MBOA. It will be understood, however, that other wireless networking standards might be used in other embodiments.

In one embodiment, the frame 300 comprises: a header 302, beacon parameters 304 and Feedback Information Element(s) 306. Header 302 may contain routing information for the frame. Beacon parameters 304 can indicate signaling methods in use by the wireless devices. Feedback Information Element(s) 306 may include just about any feedback information that might normally be included in an Imm-ACK, Block-ACK, or other acknowledgement message.

According to various embodiments a receiver may include information elements (“IEs”) in its beacon to send feedback information about packets received during, e.g., previous superframe(s). The beacon may, for example, be in a superframe. The information elements can then be used to send feedback information about packets received during the previous superframe(s). For example, a beacon containing information elements that include feedback information might be used in a WiMedia wireless network or other wireless network.

The feedback information transmitted as part of an information element in a beacon may contain some acknowledgement information for packets received for a specific data stream that have the ACK policy set to No-ACK. In this way, feedback information can be transmitted from a receiving wireless device to a transmitting wireless device without the overhead associated with, for example, an Imm-ACK or Block-ACK.

One example of such a No-ACK feedback information element format is illustrated in Table 1. A No-ACK feedback information element format might include element identification bits, for example, an octet (8 bits). The No-ACK feedback information element might, in one embodiment, be of a variable length. Accordingly, some bits, e.g., an octet, may indicate the length of the No-ACK feedback information element. Additionally, the feedback bits may be included.

TABLE 1
No-Ack Feedback IE format

| octets: 1 | 1 | 4 | . . . | 4 |
|---|---|---|---|---|
| Element ID | Length | Feedback 1 | | Feedback k |
| | (=4 × N) | | | |

While many systems might format the bits in the order illustrated in Table 1, it will be understood by those of skill in the art that other formats are possible. For example, the size and order of each of these fields may vary from implementation to implementation.

According to some embodiments, the feedback information may contain some acknowledgement information for packets received for a specific data stream that have the ACK policy set to No-ACK. For example, the feedback information may include information elements that include acknowledgement information that acknowledge the reception of previously transmitted packets. This information may be used to construct measures of various communication signal properties such as, for example, packet error rates.

According to another embodiment, the feedback may include periodic error rates for a stream. Additionally, according to another embodiment, each the feedback might specify a certain source device. For example, the source device may be indicated by the device address (“DevAddr”). One example embodiment that includes DevAddr, stream index and periodic error rate fields is illustrated in Table 2. As illustrated in Table 2, these fields may be various sizes, for example, the DevAddr might be two octets and the stream index and periodic error rate fields might each be 1 octet. While many systems might format the bits in the order illustrated in Table 2, it will be understood by those of skill in the art that other formats are possible. For example, the size and order of each of these fields may vary from implementation to implementation.

TABLE 2
Feedback field format

| octets: 2 | 1 | 1 |
|---|---|---|
| DevAddr | Stream | PER |
| | Index | |

In some embodiments, a receiver may include this information whenever it receives packet that have the ACK policy set to No-ACK only when the transmitters indicates its wish to receive such information, or may include that feedback in every beacon. A transmitter may indicate its wish to receive such information by including an information element in its beacon.

In one embodiment, a receiver may include feedback whenever it receives packets that have the ACK policy set to No-ACK and the transmitter indicates its wish to receive such information. In another embodiment, a receiver may include the feedback information in every beacon. A transmitter may indicate its wish to receive such information by including an information element in its beacon. An example of the format of such information element is illustrated in Table 3, below:

TABLE 3
Send Feedback IE format

| octets: 1 | 1 | 3 | . . . | 3 |
|---|---|---|---|---|
| Element ID | Length | Send | | Send |
| | (=3 × N) | Feedback 1 | | Feedback k |

As illustrated in Table 3, an example of the format of such an information element might include a single octet element identification field, followed by a single octet length field and some number of three-octet Send Feedback fields. The Send Feedback fields (1 . . . k) illustrated in Table 3 may be formatted as illustrated in Table 4. For example, the Send Feedback field may be formatted to include two octets for the DevAddr and one octet for the stream index. While many systems might format the bits in the order illustrated in Table 3, it will be understood by those of skill in the art that other formats are possible. For example, the size and order of each of these fields may vary from implementation to implementation.

TABLE 4
Send Feedback field format

| octets: 2 | 1 |
|---|---|
| DevAddr | Stream |
| | Index |

According to one embodiment, a source device can input any feedback information it receives into its link adaptation algorithm in order to improve a certain performance measure. For example, the feedback information can significantly improve the performance of adaptive transmission techniques at the source device by helping the source to determine the best transmission rate and packet size to adapt to wireless channel variations. In addition to determining the best transmission rate, packet size, etc., the link adaptation algorithm might modify other aspects of the wireless communication network with the goal of improving performance, including, for example, changing transmit signal power, transmit frequency, or other modifications.

While many systems might format the bits in the order illustrated in Table 4, it will be understood by those of skill in the art that other formats are possible. For example, the size and order of each of these fields may vary from implementation to implementation.

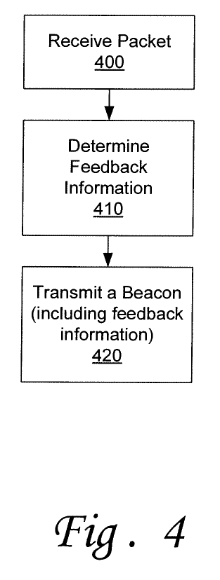

FIG. 4 is a flowchart illustrating one example method for transmitting feedback information, such as acknowledgement information in accordance with one embodiment of the systems and methods described herein. The feedback information may be transmitted, for example, from one wireless electronic device to another wireless electronic device in a wireless network. The wireless network might be, for example, a WiMedia-MBOA (Multiband OFDM Alliance) wireless network. Alternatively, in other embodiments the network may include the Bluetooth(t communications network and various IEEE standards-based networks such as 802.11 and 802.16 communications networks, to name a few.

The feedback information can include information about packets received. These packets might be received, e.g., during previous superframes. The information about packets received during previous superframe(s) may also contain acknowledgement information from packets received. For example, the feedback might be used when the acknowledgement policy of the network is set to No-ACK. When the acknowledgement policy of the network is set to No-ACK, no acknowledgement is sent using the acknowledgment methods previously known in the WiMedia MAC Protocol.

In a step 400, a packet is received. The receiving device may determine various information regarding the received packet. For example, in addition to the data received that is included in the packet, the receiving device may determine packet error rates and other measures that indicate the quality of the transmitted packet, these might include, for example: bit-error rates, signal-to-noise ratios, received power, etc. Additionally, the wireless device might receive reflected signals. In some cases the receive device may be able to determine timing, signal strength, or other information about these reflected signals. These signals may give an indication of the environment in which the sending or receiving device is operating, for example, an area with tall buildings, or other objects that might reflect signals. This information might be used to provide feedback to the transmitting device.

In a step 410, any feedback to be sent in a beacon may be determined. The feedback information includes information about packets received, such as acknowledgement information. The feedback might include packet error rates, bit-error rate, signal-to-noise ratio, received power and other measures that indicate the quality of the transmitted packet. This feedback might allow the transmitting device to select another data transmission rate, select a different packet size, increase or decrease transmit power, or take other corrective action based on current network conditions.

The feedback might also include information regarding reflected signals. Information regarding such signals may be included in the information elements that are transmitted as part of the beacon. This may allow the transmitting device to, for example, change transmission frequency to find a different frequency that might be less prone to the reflections, or take other corrective action, such as, for example, select another data transmission rate, select a different packet size, increase or decrease transmit power, or other corrective action.

In a step 420, a beacon can be transmitted that includes feedback information. In this way, a wireless device can transmit the feedback information without using other transmission time that might be used to transmit data. For example, without using Imm-ACK or Block-ACK as defined in the WiMedia MAC Protocol. Accordingly, transmission bandwidth will not be lost to, e.g., Imm-ACK or Block-ACK transmissions.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for a network device to transmit feedback information comprising:
receiving a packet from a source device;
determining feedback information, the feedback information including acknowledgement information, that includes a measure of signal quality, the measure of signal quality determined based on the received packet from the source device; and
transmitting a beacon during a beacon slot, in a beacon period of a superframe, wherein the beacon comprises:
a frame header, including routing information for the frame;
a beacon parameter, including signaling information; and
an information element comprising the feedback information from the received packet, including the measure of signal quality determined using the received packet.

2. The method of claim 1, wherein the information element includes a device address.

3. The method of claim 1, further comprises determining that an acknowledgement policy is set to No-ACK.

4. The method of claim 3, wherein a receiver includes the information element in the beacon when the acknowledgement policy is set to No-ACK.

5. The method of claim 1, wherein a receiver includes the information element in the beacon when a transmitter indicates that such information should be transmitted.

6. The method of claim 6, further comprising indicating that the receiver should include the information element in the beacon by including an information element in its beacon.

7. The method of claim 1, wherein a receiver includes the information element in every beacon.

8. The method of claim 1, further comprising receiving the information element that comprises acknowledgement information for the received packets and processing the information element using an adaptation algorithm.

9. The method of claim 1, wherein the feedback information comprises acknowledgement information.

10. The method of claim 1, wherein the beacon period and the superframe follow the WiMedia standard.

11. A wireless device comprising:
an RF receiver configured to receive a packet;
an RF transmitter; and
a processor configured to:
determining feedback information, the feedback information including acknowledgement information, that includes a measure of signal quality, the measure of signal quality determined based on the received packet from the source device; and
cause the transmitter to transmitting a beacon during a beacon slot, in a beacon period of a superframe, wherein the beacon comprises:
a frame header, including routing information for the frame;
a beacon parameter, including signaling information; and
an information element comprising the feedback information from the received packet, including the measure of signal quality determined using the received packet.

12. The wireless device of claim 11, wherein the processor is further configured to cause the transmitter to transmit a beacon wherein the information element includes a device address.

13. The wireless device of claim 11, wherein the processor is further configured to determine that an acknowledgement policy is set to No-ACK and to cause the transmitter to transmit a beacon that includes the information element when the acknowledgement policy is set to No-ACK.

14. The wireless device of claim 11, wherein the processor is further configured to include the information element in the beacon when another wireless device indicates that such information should be transmitted.

15. The wireless device of claim 11, wherein the feedback information comprises acknowledgement information.

16. The wireless device of claim 11, wherein the device is configured to operate using a beacon period and a superframe that follow the WiMedia standard.

17. A wireless device comprising:
an RF receiver configured to receive a beacon during a beacon slot, in a beacon period of a superframe;
an RF transmitter; and
a processor configured to process the beacon, the beacon comprising:
a frame header, including routing information for the frame;
a beacon parameter, including signaling information; and
an information element comprising feedback information for the received packets.
an information element comprising feedback information from packet received at another wireless device, including a measure of signal quality determined using the packet received at the other device.

18. The wireless device of claim 17, wherein the processor is further configured to indicating that another wireless device should include the information element in the beacon by including an information element in its beacon.

19. The wireless device of claim 17, wherein the processor is further configured to receive the information element that comprises acknowledgement information for the received packets and processing the information element using an adaptation algorithm.

20. The wireless device of claim 17, wherein the feedback information comprises acknowledgement information.

21. The wireless device of claim 17, wherein the device is configured to operate using a beacon period and a superframe that follow the WiMedia standard.

22. A beacon frame, for transmission during a beacon slot in a beacon period of a superframe, the beacon frame comprising:
a frame header, including routing information for the frame;
a beacon parameter, including signaling information; and
an information element comprising feedback information from a received packet, including a measure of signal quality determined using the received packet.

23. The beacon frame of claim 22, wherein the feedback information comprises acknowledgement information.

24. The beacon frame of claim 22, wherein the information element includes a device address.

25. The beacon frame of claim 22, wherein the beacon period and the superframe follow the WiMedia standard.
